(19) United States
(12) Patent Application Publication
(10) Pub. No.: US 2008/0153699 A1
(43) Pub. Date: Jun. 26, 2008

(54) Carbonless calendar copying system

(76) Inventors: Craighton Berman, Chicago, IL (US); Rick Ellison, Chicago, IL (US); Iulius Lucaci, Evanston, IL (US); Kurt Sward, Deerfield, IL (US); Evan Ward, Chicago, IL (US)

Correspondence Address: MCDERMOTT, WILL & EMERY LLP, 227 WEST MONROE STREET, SUITE 4400, CHICAGO, IL, 60606-5096, US

(21) Appl. No.: 11/644,405

(22) Filed: Dec. 21, 2006

(51) Int. Cl. B41M 5/132

(52) U.S. Cl. 503/226

(57) ABSTRACT

The present invention generally provides a copying system, preferably for a personal calendar system, whereby notes can be transferred from a notepad to a single sheet of the calendar by writing the information while the note sheet is positioned on the calendar sheet. A separator or other backing board is not needed to ensure that the information is not transferred to additional calendar pages in the stack of calendar pages. In one embodiment the calendar sheets have a first surface and a second surface, the first surface having carbonless developer material thereon. Conversely, the notepad sheets have a first surface and a second surface, the second surface having a carbonless color-former material thereon. Additionally, the notepad sheets have a removable and repositionable pressure sensitive adhesive on at least a portion of the second surface thereof. Preferably, the carbonless color-former material on the second surface of the notepad sheets are adapted to interact with the carbonless developer material on an adjacent first surface of one of the calendar sheets to enable an image to be transferred from one of the notepad sheets to one of the calendar sheets when pressure is applied on the first surface of the notepad sheet that is in contact with the first surface of the adjacent calendar sheet.

### CROSS-REFERENCE TO RELATED APPLICATIONS

Not Applicable.

### FEDERALLY SPONSORED RESEARCH OR DEVELOPMENT

Not Applicable.

### TECHNICAL FIELD

The present invention relates generally to a carbonless copying system, and more specifically to a carbonless copying system adapted to transfer images from a notepad sheet to a single calendar sheet without permitting the image to be transferred to adjacent calendar sheets, if so desired.

### BACKGROUND OF THE INVENTION

Carbonless copying systems are well known in the art. While such carbonless copying systems according to the prior art provide a number of advantageous features, they nevertheless have certain limitations. The present invention seeks to overcome certain of these limitations and other drawbacks of the prior art, and to provide new features not heretofore available. A full discussion of the features and advantages of the present invention is deferred to the following detailed description, which proceeds with reference to the accompanying drawings.

### SUMMARY OF THE INVENTION

The present invention generally provides a customizable carbonless copying system whereby notes can be transferred from a notepad sheet to a single sheet of paper by writing the information on the notepad sheet while the notepad sheet is positioned on the paper. A separator or other backing board is not needed to ensure that the information is not transferred to additional pages in the stack.

According to one embodiment, the carbonless copying system comprises a first grouping of flexible sheets and a second grouping of flexible sheets. The flexible sheets of the first grouping have a first surface and a second surface, and preferably both the first surface and the second surface of these sheets have a carbonless developer material thereon. Conversely, the flexible sheets of the second grouping have a first surface and a second surface, but only the second surface of the flexible sheets of the second grouping has a carbonless color-former material thereon.

According to another embodiment, the carbonless color-former material on the second surface of the flexible sheets of the second grouping is adapted to interact with the carbonless developer material on an adjacent first surface of one of the flexible sheets of the first grouping to enable an image to be transferred from one of the flexible sheets of the second grouping to one of the flexible sheets of the first grouping when pressure is applied on the first surface of the flexible sheet of the second grouping having a second surface that is in contact with a first surface of the adjacent flexible sheet of the first grouping.

According to another embodiment, the flexible sheets of the second grouping further have a removable and repositionable pressure sensitive adhesive on at least a portion of the second surface thereof. Further, in another embodiment the flexible sheets of the second grouping are separably connected to one another by the removable and repositionable pressure sensitive adhesive.

According to another embodiment, the first surface of the flexible sheets of the second grouping is generally free of any carbonless color-former material.

According to another embodiment, the first and second surfaces of the flexible sheets of the first grouping are generally free of any carbonless color-former material.

According to another embodiment, the carbonless developer material is provided only on select areas of the first surface of the flexible sheets of the first grouping, and other select areas of the first surface of the flexible sheets of the first grouping are free from the carbonless developer material.

According to another embodiment, the carbonless color-former material on the second surface of the flexible sheets of the second grouping of flexible sheets comprises a layer of microcapsules containing an encapsulated dye dissolved in a solvent.

According to another embodiment, the carbonless developer material of the first surface of the flexible sheets of the first grouping of flexible sheets comprises a layer of color developing material.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of one embodiment of the carbonless copying system;

FIG. 2 is a partially exploded perspective view of the carbonless copying system with a blank notepad sheet and a blank sheet of the first grouping;

FIG. 3 is a perspective view of the carbonless copying system of FIG. 2 with images written on the notepad sheet that is on the sheet of the first grouping;

FIG. 4 is a partially exploded perspective view of the carbonless copying system of FIG. 2 with the used notepad sheet removed from the sheet of the first grouping;

FIG. 5 is a partially exploded perspective view of the carbonless copying system of FIG. 2 showing the sheet of the first grouping having a transferred image and the sheet being removed from the remaining sheets of the first grouping;

FIG. 6 is a partial cross-sectional side view of an illustration of a writing pressure being applied to a notepad sheet positioned on a sheet of the first grouping; and,

FIG. 7 is an exploded cross-sectional side view of the carbonless copying system of FIG. 6 with the writing pressure removed.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

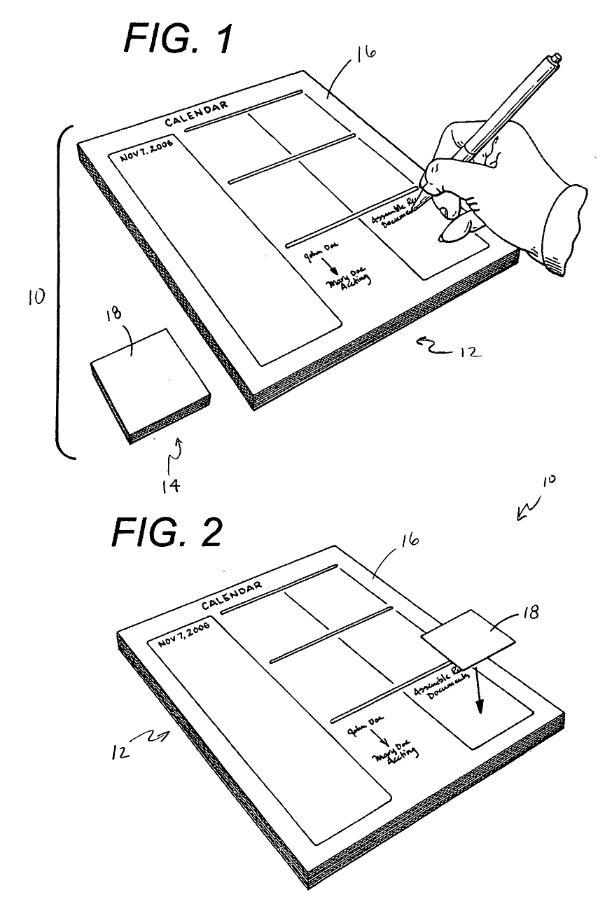

Referring now to the Figures, and specifically to FIG. 1, there is shown a carbonless copying system 10. The carbonless copying system 10 generally comprises a first grouping 12 of a plurality of flexible sheets 16, and a second grouping 14 of a plurality of flexible sheets 18. The various surfaces of the flexible sheets 16, 18 of the different groupings 12, 14 have different carbonless copying/image transfer materials associated therewith to provide for controlled image transfer between the two groupings 12, 14 of flexible sheets 16, 18.

In one embodiment the first grouping 12 of flexible sheets 16 comprises a calendar planner, wherein each calendar sheet 16 is provided for a different day, different week, different month, etc. In a preferred embodiment, each sheet 16 of the first grouping 12 represents a different day of the year. Each sheet 16 of the first grouping 12 generally has a first or top surface 20 and a second or bottom surface 22. Further, in one embodiment the sheets 16 of the first grouping 12 are generally not connected directly together, but rather are bound in a grouping, such as in a spiral or three-ring binder, or some other type of notebook.

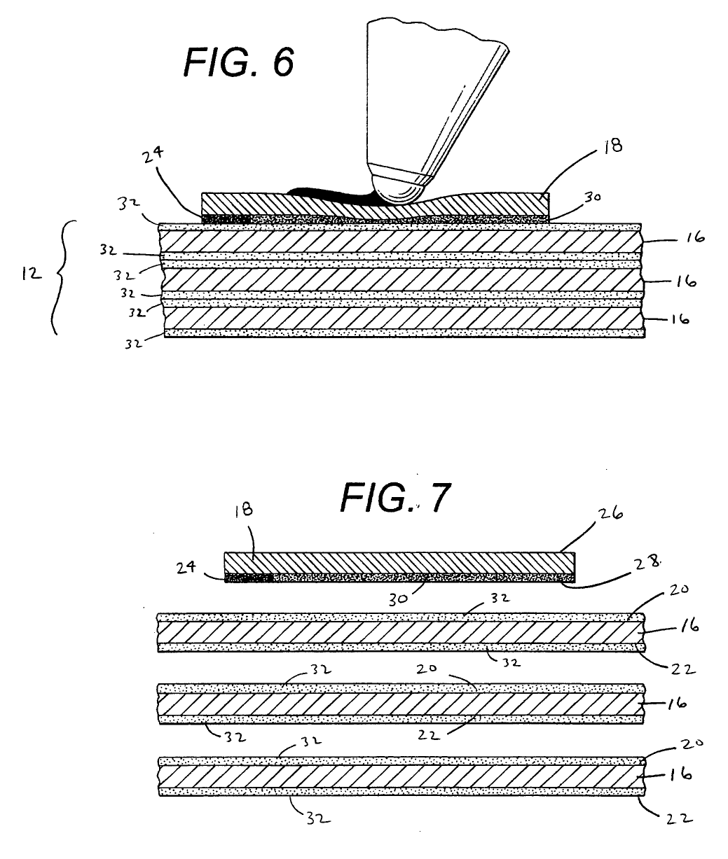

Similarly, in one embodiment the second grouping 14 of flexible sheets 18 comprises a notepad, such as a Post-It® notepad or other pad of adhesive note paper, wherein the sheets 18 of the second grouping 14 are separably connected to one another by a removable and repositionable pressure sensitive adhesive 24 as shown in FIGS. 6 and 7. Each sheet 18 of the second grouping 14 also generally has a first or top surface 26 and a second or bottom surface 28. In one embodiment the removable and repositionable pressure sensitive adhesive 24 is provided on a portion of the bottom surface 28 of each of the sheets 18 of the second grouping 14 to allow the sheets 18 of the second grouping 14 to be separably connected together, and also to allow the sheets 18 of the second grouping 14 to be repositionably connected to another component, such as a sheet 16 of the first grouping 12. The top sheet 18 or any number of sheets 18 of the second grouping 14 can be separated from the remaining sheets 18 merely by applying a small force to separate such sheets from the grouping 14.

As explained herein, to allow images that are written on a sheet of one of the groupings of paper 12, 14 to be transferred to a sheet of the other grouping of paper 14, 12, various carbonless image transfer materials and/or carbonless copying materials are provided on the different surfaces of the sheets 16, 18 of the groupings of paper 12, 14. Carbonless copy papers are those which are capable of producing an image on a second sheet upon the application of pressure. Products employing this technology generally contain at least two substrates (i.e., sheets of flexible paper), and involve coatings on the various surfaces of the substrates. In one process a first reactant, known as a color-former material 30, is provided or coated on at least one surface of the sheets or substrates, and a second reactant, known as a developer material 32 is provided or coated on at least one surface of another of the sheets or substrates. The two different sheets or substrates are often referred to as a donor sheet and a receptor sheet.

Typically, the donor sheet has the color-former material 30 comprising, in one embodiment, a layer of microcapsules encapsulated with a solution of the color-former that is dissolved in an appropriate hydrophobic solvent, and then coated with a suitable binder onto a surface of a flexible sheet to form the donor sheet. Because the color-former material 30 is typically provided on the back side of the appropriate flexible donor sheets the donor sheet is often referred to as having the “coated back” or CB surface or sheet. In one embodiment each CB surface generally contains rupturable capsules which, when ruptured, release reagents to produce a color-changing reaction at the adjacent receptor sheet. The microcapsules serve the purpose of isolating the reactants from one another and preventing reaction prior to pressure being applied to the paper.

Similarly, the receptor sheet typically has a developer material 32 thereon, also optionally in a suitable binder such as a starch or later, that is generally coated onto a surface of a flexible sheet to form the receptor sheet. The term “suitable binder” generally refers to a material, such as a starch or latex, which allows for dispersion of the reactants in a coating on a substrate. The receptor sheet having the developer layer 32 is often referred to as the “coated front” or CF sheet because the developer layer is typically provided on the front side or surface of such a flexible sheet. While it is customary to coat the color-former capsules on the back surface and to coat the developer on the front surface, this procedure can be reversed or modified, as desired.

As shown in FIGS. 6 and 7, in a preferred embodiment, the flexible sheets 16 of the first grouping 12 have a first surface 20 and a second surface 22. In one embodiment both the first and second surfaces 20, 22 have a carbonless developer material 32 (CF) thereon. In alternate embodiments, however, only the first surface 20 or the second surface 22 of the flexible sheets 16 of the first grouping 12 are coated with a carbonless developer material 32 (CF), and the other surface is free of the carbonless developer material 32 (CF). In further alternate embodiments, specific areas of the first and/or second surfaces 20, 22 of the flexible sheets 16 of the first grouping 12 are spot coated with the carbonless developer material 32 (CF), and other select areas of the first and/or second surfaces 20, 22 of the flexible sheets 16 of the first grouping 12 are free from the carbonless developer material 32. The coated areas are referred to as “live zones” and the non-coated areas are referred to as “dead zones.” In this manner, image transfer is controlled and allowed only in specific areas of the page. Additionally, it is understood that in preferred embodiments the first and second surfaces 20, 22 of the flexible sheets 16 of the first grouping 12 are free from any carbonless color-former 30 material (i.e., CB) thereon. This allows the written image on a notepad sheet 18 to be transferred only to a single surface of the calendar sheet 16, without transferring to any additional calendar sheet 16, and without having to utilize a separate separator or board under the initial calendar sheet 16.

Also as shown in FIGS. 6 and 7, in a preferred embodiment the flexible sheets 18 of the second grouping 14 have a first surface 26 and a second surface 28. The second surface 28 of the flexible sheets 18 of the second grouping 14 preferably have a carbonless color-former material 30 (CB) thereon. Additionally, as shown in FIGS. 6 and 7, in a preferred embodiment the first surface 26 of the flexible sheets 18 of the second grouping 14 are generally free of both any carbonless color-former material 30 and any carbonless developer material 32.

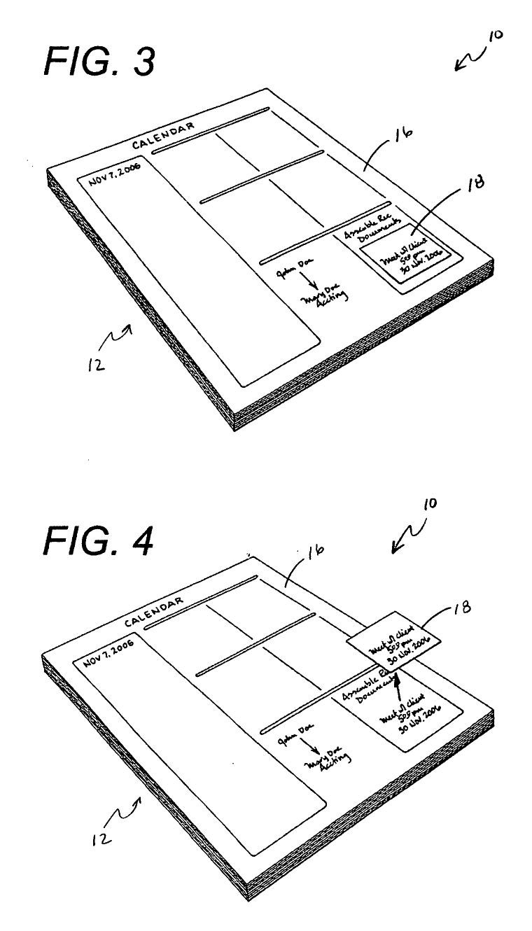

To transfer an image from the notepad sheet 18 to a sheet 16 of the first grouping 12 in a preferred embodiment, a flexible notepad sheet 18 is first separated from the second grouping 14 of flexible sheets 18 (see FIG. 2). The two adjacent sheets (i.e., flexible sheet 14 and flexible notepad sheet 18) are positioned such that the back surface 28 of the notepad sheet 18 (i.e., the donor sheet) having the color-former material 30 (i.e., CB) is positioned on the front surface 20 of an adjacent sheet 16 having the developer material 32 (i.e., CF), as shown in FIG. 3. As explained herein and best shown in FIGS. 4-6, the carbonless color-former material 30 on the second surface 28 of the flexible sheets 18 of the second grouping 14 is adapted to interact with the carbonless developer material 32 on an adjacent first surface 20 of one of the flexible sheets 16 of the first grouping 12 to enable an image that is written on the notepad sheet 18 to be transferred to the adjacent calendar sheet 16 when pressure is applied via the writing utensil (i.e., the pen, pencil or other writing utensil) on the notepad 18. This is because the CB 30 layer on the back side 28 of the notepad interacts with the CF 32 layer on the adjacent surface (shown as the front side 20) of the calendar page 16. Such a carbonless transfer is only capable if the specific area of the surface of the calendar page 16 on which the notepad paper 18 has been coated with the carbonless developer material (CF).

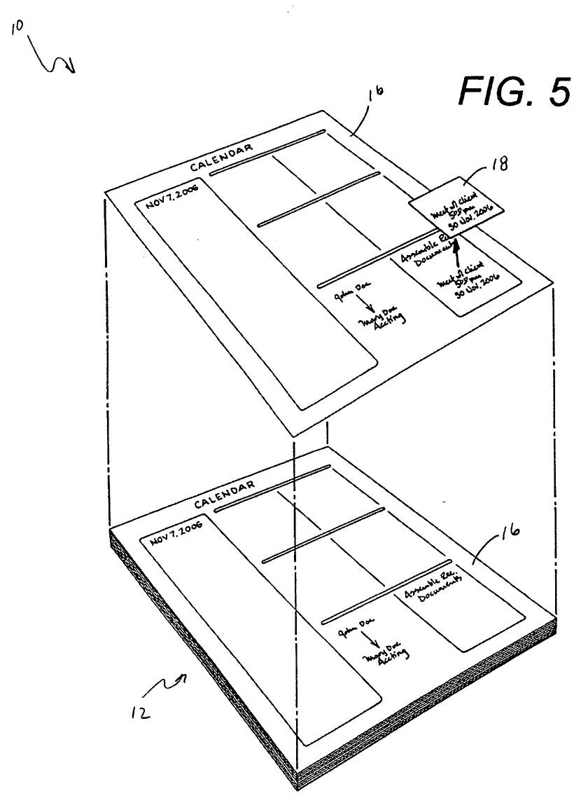

Further, even though the sheets 16 of the first grouping 12 may be coated on both surfaces 20, 22 with the carbonless developer 32 material (i.e., CF), the writing from the adjacent second grouping 14 sheet 18 is only transferred to the single adjacent surface of the calendar sheet 16 (see FIG. 5). Additionally, no rigid separator is required to be utilized underneath the calendar sheet 16 because the image transfer requires an interaction between the CB and the CF. The only interaction between adjacent calendar sheets 16 of the first grouping 12 is a CF to CF interaction, which does not result in any imaging transfer.

Alternatively, it is understood that the configuration of the carbonless color-former material 30 (CB) and the carbonless developer material 32 (CF) may be reversed on the different groupings 12, 14 without departing from the spirit and scope of the present invention.

Similarly, when a user writes on one of the daily calendar pages 16 in the stack 12 without utilizing a notepad sheet 18, no carbonless image transfer will occur because the interaction of each page is merely a CF to CF interaction—resulting in no chemical reaction. Conversely, when the user desires to write a note on a notepad sheet 18, and to have the information be transferred on a page 16 of the daily calendar without having to write the note twice (once on the note paper 18 and once on the daily calendar page 16), the user places the note paper 18 in the proper location on the calendar page 16 and writes on the note paper 18. Because of the chemical interaction between the back surface 28 of the note paper 18 (CB coated) with either the front or rear surface 20, 22 of the adjacent daily calendar page 16 (CF coated), a carbonless copy will be provided on the immediately adjacent surface of the calendar page 16. The carbonless copy will not transfer to any other page or surface, however, because all other surface of the daily calendar pages 16 have a CF to CF interaction, resulting in no chemical reaction. Accordingly, this system allows for perfect management of carbonless copies without the need for cardboard inserts to block the transfer of pressure. Typically, the user will maintain possession of the daily calendar page 16 with the copied information, and can provide the note paper 18 to an assistant, such as a secretary, for further recording or for placement as desired.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. Additionally, the terms “first,” “second,” “third,” and “fourth” as used herein are intended for illustrative purposes only and do not limit the embodiments in any way. Further, the term “plurality” as used herein indicates any number greater than one, either disjunctively or conjunctively, as necessary, up to an infinite number. Additionally, the term “having” as used herein in both the disclosure and claims, is utilized in an open-ended manner.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind without significantly departing from the spirit of the invention and the scope of protection is only limited by the scope of the accompanying Claims.

What is claimed is:

1. A carbonless copying system, comprising:
a first grouping of flexible sheets, the flexible sheets having a first surface and a second surface, the first surface having carbonless developer material thereon; and,
a second grouping of flexible sheets, the flexible sheets having a first surface and a second surface, the second surface of the flexible sheets of the second grouping having a carbonless color-former material thereon, the flexible sheets of the second grouping further having a removable and repositionable pressure sensitive adhesive on at least a portion of the second surface thereof, and the first surface of the flexible sheets of the second grouping being generally free of any carbonless color-former material, the carbonless color-former material on the second surface of the flexible sheets of the second grouping being adapted to interact with the carbonless developer material on an adjacent first surface of one of the flexible sheets of the first grouping to enable an image to be transferred from one of the flexible sheets of the second grouping to one of the flexible sheets of the first grouping when pressure is applied on the first surface of the flexible sheet of the second grouping having a second surface that is in contact with a first surface of the adjacent flexible sheet of the first grouping.

2. The carbonless copying system of claim 1, wherein the first and second surfaces of the flexible sheets of the first grouping are generally free of any carbonless color-former material.

3. The carbonless copying system of claim 1, wherein the second surface of the flexible sheets of the first grouping is generally free of any carbonless developer material thereon.

4. The carbonless copying system of claim 1, wherein the second surface of the flexible sheets of the first grouping has a carbonless developer material thereon.

5. The carbonless copying system of claim 1, wherein the carbonless developer material is provided only on select areas of the first surface of the flexible sheets of the first grouping, and wherein other select areas of the first surface of the flexible sheets of the first grouping are free from the carbonless developer material.

6. The carbonless copying system of claim 1, wherein the first surface of each of the plurality of flexible sheets of the first and second groupings is a front surface, and wherein the second surface of each of the plurality of flexible sheets of the first and second groupings is a bottom surface.

7. The carbonless copying system of claim 1, wherein the flexible sheets of the second grouping are separably connected to one another by the removable and repositionable pressure sensitive adhesive.

8. The carbonless copying system of claim 1, wherein the flexible sheets of the first grouping are not directly connected to one another.

9. The carbonless copying system of claim 1, wherein the carbonless color-former material on the second surface of the flexible sheets of the second grouping of flexible sheets comprises a layer of microcapsules containing an encapsulated dye dissolved in a solvent.

10. The carbonless copying system of claim 9, wherein the carbonless developer material of the first surface of the flexible sheets of the first grouping of flexible sheets comprises a layer of color developing material.

11. A carbonless calendar and note copying system, comprising:
a first grouping of flexible sheets having a first surface and a second surface, the first surface of the flexible sheets having calendar images thereon, and at least a portion of the first surface having one of a carbonless developer material and a carbonless color-former material thereon; and,
a second grouping of flexible note sheets having a first surface and a second surface, the flexible sheets of the second grouping having the other of a carbonless developer material and a carbonless color-former material on a portion of the second surface thereof, and the first surface of the flexible sheets of the second grouping being generally free of any carbonless color-former material and any carbonless developer material;
wherein the other of the carbonless developer material and the carbonless color-former material on the second surface of the flexible sheets of the second grouping being adapted to interact with the one of the carbonless developer material and the carbonless color-former material on an adjacent first surface of one of the flexible sheets of the first grouping to enable an image to be transferred to the flexible sheet of the first grouping when pressure is applied on the first surface of one of the flexible sheets of the second grouping having a second surface that is in contact with a first surface of one of the flexible sheets of the first grouping, and wherein the image is not transferred to other flexible sheets of the first grouping that are in contact with the flexible sheet of the first grouping contacting the flexible sheet of the second grouping.

12. The carbonless copying system of claim 11, wherein the flexible sheets of the second grouping further comprise a removable and repositionable pressure sensitive adhesive on a portion of the second surface thereof.

13. The carbonless copying system of claim 12, wherein the flexible sheets of the second grouping are separably connected to one another by the removable and repositionable pressure sensitive adhesive.

14. The carbonless copying system of claim 11, wherein the flexible sheets of the first grouping are not directly connected to one another.

15. The carbonless copying system of claim 11, wherein the second surface of the flexible sheets of the first grouping has the same one of the carbonless developer material and carbonless color-former material thereon that is on the first surface thereof.

16. The carbonless copying system of claim 11, wherein the one of the carbonless developer material and the carbonless color-former material on the first surface of the flexible sheets of the first grouping is provided only on select areas of the first surface of the flexible sheets of the first grouping, and wherein other select areas of the first surface of the flexible sheets of the first grouping are free from the one of the carbonless developer material and the carbonless color-former material.

17. A carbonless copying system, comprising:
a first grouping of flexible sheets having a first surface and a second surface, the first and second surfaces having carbonless developer material thereon, and the first and second surfaces not having any carbonless color-former material thereon; and,
a second grouping of flexible note pad sheets having a first surface and a second surface, the second surface of the flexible sheets of the second grouping having a carbonless color-former material thereon, the flexible sheets of the second grouping further having a removable and repositionable pressure sensitive adhesive on at least a portion of the second surface thereof, and the first surface of the flexible sheets of the second grouping being generally free of any carbonless color-former material, the carbonless color-former material on the second surface of the flexible sheets of the second grouping being adapted to interact with the carbonless developer material on an adjacent first surface of one of the flexible sheets of the first grouping to enable an image to be transferred from one of the flexible sheets of the second grouping to one of the flexible sheets of the first grouping when pressure is applied on the first surface of the flexible sheet of the second grouping having a second surface that is in contact with a first surface of the adjacent flexible sheet of the first grouping.

18. The carbonless copying system of claim 17, wherein the first and second surfaces of the sheets of the first grouping have calendar images thereon.

19. The carbonless copying system of claim 17, wherein the flexible sheets of the second grouping are separably connected directly to one another by the removable and repositionable pressure sensitive adhesive.
